(19) United States
(12) Patent Application Publication
(10) Pub. No.: US 2026/0314545 A1
(43) Pub. Date: Oct. 15, 2026

(54) Felling Wedge

(71) Applicant: Andreas Stihl AG & Co. KG, Waiblingen (DE)

(72) Inventors: Kristian Blessing, Bad Boll (DE); Christopher Tost, Auenwald (DE); David Stäbler, Ostfildern (DE); Joshua Specht, Alfdorf (DE); Michael Varga, Stuttgart (DE)

(73) Assignee: Andreas Stihl AG & Co. KG, Waiblingen (DE)

(21) Appl. No.: 19/636,087

(22) Filed: Apr. 1, 2026

(30) Foreign Application Priority Data
Apr. 7, 2025 (DE) 102025113597.5
Sep. 12, 2025 (DE) 102025136879.1

(51) Int. Cl. A01G 23/099

(52) U.S. Cl. CPC A01G 23/099

(57) ABSTRACT

A felling wedge (1) includes a base body (10), a pressure wedge body (20) movable relative to the base body (10), a drive unit (40) that moves the pressure wedge body (20) relative to the base body (10) along a longitudinal axis (49) in an extending direction (50), and a handle area (30) associated with the base body (10). The felling wedge (1) has a rear end (2) and a front end (3) with respect to the extending direction (50). The handle area (30) extends in a transverse direction (48) transverse to the longitudinal axis (49) and is arranged between the rear end (2) and the front end (3).

### CROSS-REFERENCE TO RELATED APPLICATIONS

This application claims the benefit of German Patent Applications DE 102025113597.5, filed on Apr. 7, 2025, and DE 102025136879.1, filed on Sep. 12, 2025, the entire contents of which are incorporated by reference.

### TECHNICAL FIELD

The disclosure relates to a felling wedge.

### BACKGROUND

A felling wedge is used when felling a tree. Typically, a motor chain saw is first used to make a wedge-shaped notch on the side of the tree facing the direction of fall. Then, on the opposite side of the tree, typically at a greater distance from the ground than the notch, a felling cut is made to form an, in particular wedge-shaped, cutting gap. The felling wedge is then introduced into the cutting gap. The felling wedge acts in the cutting gap to support and influence movement of the tree during felling.

### SUMMARY

A felling wedge comprises a base body, which can be fixed in position relative to the tree, in particular relative to the cutting gap. The felling wedge comprises a pressure wedge body that is moveable in relation to the base body. In order to move the pressure wedge body in relation to the base body, a drive unit is provided. In order to fell the tree, the pressure wedge body is driven by means of the drive unit into the tree, in particular into the cutting gap, while the base body is fixed in position in the cutting gap. In the process, the pressure wedge body typically advances in the direction in which the tree is intended to fall. However, it can also be provided that the pressure wedge body advances into the cutting gap in a direction transverse to the direction of fall of the tree. The pressure wedge body widens the cutting gap so that the tree is pushed in the desired direction and ultimately falls.

The handle area runs transverse to the longitudinal axis and is arranged, in particular with respect to the extending direction, between the rear end and the front end of the felling wedge. As a result, the felling wedge can be carried ergonomically by the handle area, in particular with one hand. In particular, the handle area can hang or dangle from a hand, in particular from one or multiple fingers of the hand. In addition, since the centre of mass of the felling wedge is located between the rear end and the front end of the felling wedge, the weight of the felling wedge can be supported close to the centre of mass. Because the handle area runs transverse to the longitudinal axis, the user will always support the felling wedge at almost the same point with respect to the extending direction. Thus, the centre of mass and the point at which the user takes up the weight via the handle area are always oriented very similarly or identically to one another. The felling wedge can then always be in a similar or the same position relative to the user when it is being carried. This happens almost automatically, as the user always supports the felling wedge with respect to the extending direction at a similar or the same point owing to the transverse handle area. When the felling wedge is being used, the handle area can also be used to drive the felling wedge, in particular the base body of the felling wedge, into a cutting gap of a felling cut of a tree to be felled. In particular, due to the orientation of the handle area transverse to the longitudinal axis, along which the pressure wedge body is extendable, the hand resting against the handle area can be used to exert force particularly efficiently and ergonomically onto the felling wedge, in particular in the extending direction. As a result, the felling wedge can be introduced simply and efficiently into the cutting gap of the felling cut. Because the handle area is arranged between the rear end and the front end of the felling wedge, the weight of the felling wedge can be supported efficiently and close to a centre of mass of the felling wedge when the latter is being carried by using the handle area. In particular, the felling wedge can be carried by the handle area such that the front end of the felling wedge points forwards, in particular such that the longitudinal axis is oriented at an angle of from 0° to 45°, in particular from 0° to 30°, in particular from 0° to 20°, relative to a horizontal plane. This makes it easy to position and/or use the felling wedge. Moreover, it also makes it possible to easily carry the felling wedge.

Advantageously, the handle area is arranged, with respect to the extending direction, in a middle third of the felling wedge between the rear end and the front end of the felling wedge. As a result, the handle area can be arranged close to centre of mass of the felling wedge. In particular, the centre of mass is arranged with respect to the extending direction in the middle third of the felling wedge.

The felling wedge can be arranged on a horizontal plane in an operating position. Expediently, in the operating position of the felling wedge, the handle area is arranged above the longitudinal axis. As a result, the felling wedge can easily be lifted up and/or carried by means of the handle area. Expediently, the handle area is arranged above the longitudinal axis when a tree is being felled with the aid of the felling wedge.

The felling wedge has a centre of mass. When the handle area and the centre of mass are arranged in a vertical plane running in the transverse direction, the extending direction is advantageously oriented at a, in particular upwardly opening, carrying angle relative to the vertical plane. In this case, in particular, the extending direction points away from the vertical plane. In particular, the carrying angle is from 50° to 90°, in particular from 60° to 80°, in particular from 65° to 75°. As a result, the felling wedge can be carried ergonomically. The extending direction of the felling wedge or of the pressure wedge body can point forwards when the felling wedge is carried by the handle area. The felling wedge can therefore be used and/or positioned rapidly. Due to the carrying angle, the extending direction can point slightly upwards when the felling wedge is carried by the handle area. This prevents the felling wedge, in particular the pressure wedge body, from getting caught on the ground, undergrowth or the like. Due to the carrying angle, the felling wedge can be carried ergonomically even though the pressure wedge body is light compared to the base body.

In particular, the handle area is tubular. Additionally or alternatively, the handle area is formed by a handle loop that straddles the base body. Due to the tube shape, the handle area can easily be grasped by a hand. The felling wedge can be carried ergonomically with a single hand. The tube shape enables the felling wedge to be introduced forcefully into the cutting gap, since it is possible to press against the tubular handle area from the rear end of the felling wedge and in particular because the handle area runs transverse to the extending direction. Because the handle area is formed by the handle loop, the handle area is easy to produce. The handle loop can protect the base body and/or pressure wedge body, in particular if the felling wedge is dropped.

The transverse direction and the extending direction are oriented at a transverse angle to each other. The transverse angle is in particular from 60° to 120°, in particular from 80° to 100°, in particular 90°. It can be provided that the handle area is curved and only runs in transverse direction at a single point. A handle area that runs, in particular exclusively, in a straight line is also conceivable.

The pressure wedge body has an inclined surface which runs at an angle to the longitudinal axis. In particular, the handle area is arranged at a hand clearance distance from the inclined surface measured in the extending direction. In particular, the hand clearance distance is at least 3 cm, in particular at least 4 cm, in particular at least 5 cm. As a result, even when the handle area is grasped with the fingers of one hand while the felling wedge is being introduced into the cutting gap, pressure can be exerted on the felling wedge without the fingers coming into contact with the tree to be felled. Due to the hand clearance distance, there is sufficient space for the fingers.

In particular, the felling wedge has a rear handle which is arranged behind the handle area with respect to the extending direction. As a result, the felling wedge can be held and/or used with two hands. In particular, while the felling wedge is being introduced into the cutting gap, pressure can be exerted on the felling wedge at both the handle area and at the rear handle. Therefore, the felling wedge can be introduced into the cutting gap particularly efficiently and deeply.

In particular, the rear handle is a loop handle. This makes it easy to grasp the rear handle and it is easy to produce. In particular, the rear handle alternatively or additionally forms the rear end of the felling wedge. As a result, the hand can easily reach the rear handle, in particular when the felling wedge is being introduced into the cutting gap. Pressure can therefore be exerted easily.

In particular, the felling wedge comprises a battery pack, in particular for supplying the drive unit with electrical power. In particular, the battery pack is arranged between the handle area and the rear handle with respect to the extending direction. As a result, the generally heavy weight of the battery pack can easily be absorbed when both the handle area and the rear handle are being used.

In particular, the felling wedge comprises a control element for controlling the drive unit. Expediently, the control element is arranged such that when the rear handle is being held, in particular grasped, with one hand, the control element can be controlled with the same hand. As a result, ergonomic control of the felling wedge, in particular of the control element, is possible.

Advantageously, the control element is arranged on the base body in such a way that it forms a movement unit with the base body when the pressure wedge body moves relative to the base body. In particular, the pressure wedge body moves relative to the base body the same amount as it does relative to the control element. In particular, the control element is able to move together with the base body relative to the pressure wedge body. As a result, regardless of the extending state of the pressure wedge body, the control element can easily be reached, in particular controlled, from the rear handle.

In particular, the control element can be removed from the base body and used as a remote control. As a result, it is easy to control the felling wedge remotely. The felling wedge can first of all be positioned in the cutting gap. In the process, the pressure wedge body can also be extended a little by means of the drive unit. The remote control arranged on the base body can then be ergonomically controlled.

In particular, the felling wedge comprises at least one rear attachment point and at least one front attachment point for attaching a carrying strap for the felling wedge. In particular, the at least one rear attachment point is arranged on the rear handle or the base body. As a result, the rear attachment point can easily be produced at a suitable point. In particular, the at least one rear fastener and/or the at least one front fastener is designed as a passage opening. This enables the carrying strap to be attached reliably. In particular, the at least one rear attachment point and/or the at least one front attachment point can be used for attaching a fall protection means for the felling wedge. In this way, the felling wedge can easily and quickly be secured against falling, in particular when carrying out felling work on a slope. Expediently, the fall protection means is a rope or a strap.

In particular, the felling wedge comprises two wedge jaws, each for arrangement between the tree and the pressure wedge body. Advantageously, the two wedge jaws are fixed to the base body. In particular, the at least one front attachment point is arranged on the front handle or on at least one of the two wedge jaws. As a result, the front attachment point can be produced easily at a suitable point.

The handle area has a first longitudinal end and a second longitudinal end. In particular, the transverse direction runs in the direction of a straight connecting line from the first longitudinal end to the second longitudinal end. In particular, the first longitudinal end and the second longitudinal end lie on a longitudinal centre line of the handle area. This is particularly the case when the handle area is tubular.

In particular, the felling wedge comprises at least one engagement means for engagement with the tree to be felled. Expediently, the base body can be fixed in position relative to the tree by means of the engagement means.

In particular, the drive unit comprises a motor, by means of which the pressure wedge body is able to move in relation to the base body.

In particular, the pressure wedge body is moveable in relation to the two wedge jaws. In particular, the two wedge jaws can be pushed apart by the pressure wedge body. In particular, the at least one engagement means is provided on the wedge jaws.

### BRIEF DESCRIPTION OF THE DRAWINGS

Exemplary embodiments of the invention are set out hereinafter with reference to the drawing, which show:

FIG. 1: a perspective illustration of a felling wedge having a handle area arranged between the rear end and the front end of the felling wedge,

FIG. 2: a side view of the felling wedge from FIG. 1, wherein the centre of mass of the felling wedge is arranged vertically below the handle area,

FIG. 3: a side view of the felling wedge from FIGS. 1 and 2, wherein the extending direction of the pressure wedge body of the felling wedge points in a horizontal direction,

FIG. 4: a plan view from above of the felling wedge from FIGS. 1 to 3 with a schematic illustration of an optional carrying strap,

FIG. 5: a side view of the felling wedge from FIGS. 1 to 4, wherein the felling wedge is positioned on a horizontal plane, and

FIG. 6: a side view of an alternative exemplary embodiment for a felling wedge having a handle area, wherein the handle area is designed as a projection of the base body, in particular as a recessed handle.

### DETAILED DESCRIPTION

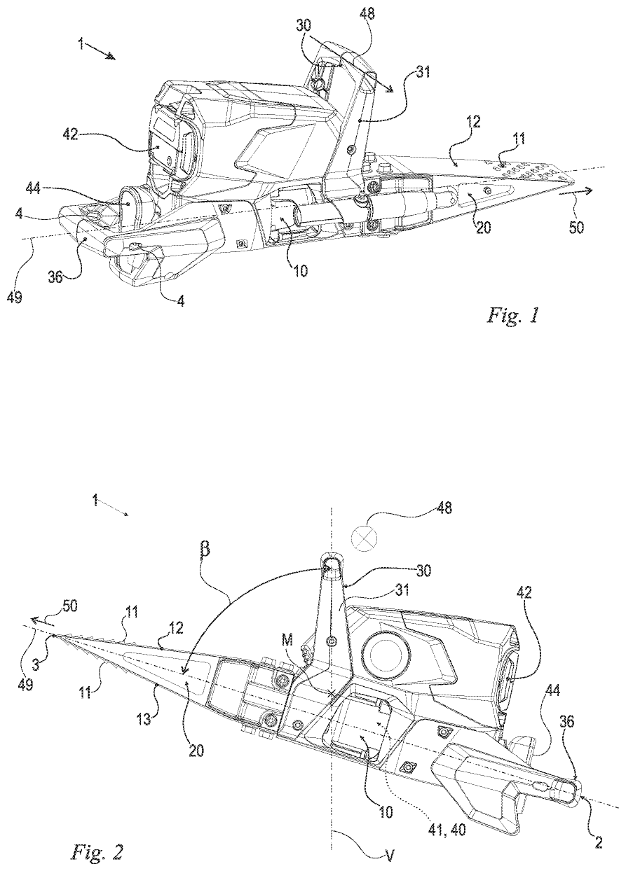

FIG. 1 shows a felling wedge 1. The felling wedge 1 is a work apparatus with which a tree to be felled is felled and can be directed to fall in a desired direction. To this end, the felling wedge 1 is inserted into a, in particular wedge-shaped, cutting gap that has been made in a tree using a tree felling saw. The cutting gap is also referred to as a felling cut. Typically, the felling cut runs in the horizontal direction. The felling cut is made opposite a notch in the trunk of the tree to be felled. After inserting the felling wedge 1 into the cutting gap, part of the felling wedge 1 is driven deeper into the cutting gap. Typically, this occurs in the direction in which the tree to be felled is intended to fall. However, the part of the felling wedge can also be driven deeper into the cutting gap in a direction transverse to, in particular at a right angle to, the direction in which the tree to be felled is intended to fall.

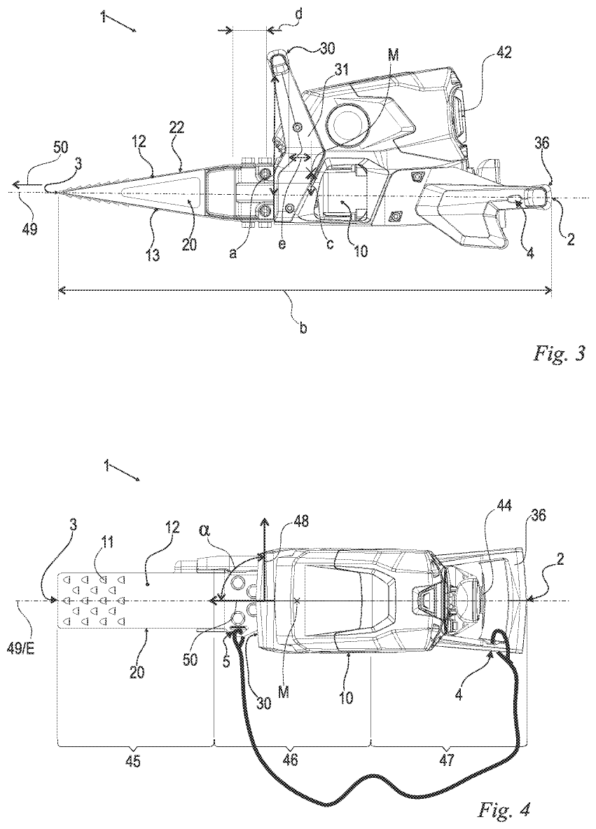

The felling wedge 1 comprises a base body 10 and a pressure wedge body 20. The pressure wedge body 20 is moveable in relation to the base body 10. When felling the tree, the pressure wedge body 20 is driven into the cutting gap in the tree. The felling wedge 1 comprises a drive unit 40. The drive unit 40 is used to drive the pressure wedge body 20 into the cutting gap in the tree when the latter is being felled. The pressure wedge body 20 is substantially wedge-shaped, as can be seen in particular in FIG. 3.

The felling wedge 1 is a mechanical felling wedge. It can be provided that the drive unit has to be operated manually. In this case, the drive unit comprises a ratchet or the like. In the exemplary embodiments, the drive unit 40 comprises a motor 41 (not shown). The motor 41 is arranged in a housing of the felling wedge 1, in particular of the base body 10. The position of the motor 41 is marked in FIG. 2 with a dotted arrow line. In the exemplary embodiments, the motor 41 is an electric motor. To supply power to the motor 41, the felling wedge 1 comprises a battery pack 42, as shown in FIGS. 1 to 3. The felling wedge 1 as per the exemplary embodiment according to FIG. 6 can also comprise a battery pack.

The felling wedge 1 comprises an engagement means 11, as shown in particular in FIGS. 1 and 2. The engagement means 11 serves to engage with the tree to be felled, in particular to engage with the cutting gap. The engagement means 11 is used to fix the base body 10 in position relative to the tree to be felled, in particular relative to the cutting gap of the tree. When the base body 10 is fixed in position in the tree to be felled by means of the engagement means 11, the pressure wedge body 20 can be extended with respect to the base body 10 and, in the process, advanced deeper into the cutting gap. Due to the wedge shape of the pressure wedge body 20, the pressure wedge body 20 enlarges the cutting gap and pushes the tree to be felled in the direction in which it is intended to fall. During this process, because it is fixed in position by the at least one engagement means, the base body 10 does not penetrate deeper into the cutting gap. The at least one engagement means 11 has a tip or a type of barb with which it can engage with the tree, in particular the cutting gap.

By means of the drive unit 40, the pressure wedge body 20 can be moved with respect to the base body 10 along a longitudinal axis 49 in an extending direction 50. When the felling wedge 1 is in use, the extending direction 50 extends in a direction away from a user who is holding the felling wedge 1. When extending the pressure wedge body 20 with respect to the base body 10 in the extending direction 50, the pressure wedge body 20 is removed from the base body 10. The pressure wedge body 20 is moved away from the base body 10. This creates a gap between the pressure wedge body 20 and the base body 10. In particular, the pressure wedge body 20 moves on a spindle (not shown). The spindle is rotated by the drive unit 40. The longitudinal direction of the spindle runs in the extending direction 50. The longitudinal axis 49 runs centrally through the spindle. Due to the pressure wedge body 20 moving away from the base body 10, the pressure wedge body 20 is spaced from the base body 10 with respect to the extending direction 50.

As shown in particular in FIGS. 2 to 5, the felling wedge 1 has a rear end 2 and a front end 3 with respect to the extending direction 50. The front end 3 of the felling wedge 1 delimits the felling wedge 1 in the extending direction 50. The front end 3 is the point or the place on the felling wedge 1 that is furthest forwards in the extending direction 50. The rear end 2 delimits the felling wedge 1 in the direction counter to the extending direction 50. The rear end 2 is the point or the place on the felling wedge 1 lying furthest to the rear with respect to the extending direction 50. When the felling wedge 1 is being used, the extending direction 50 points away from the user. The rear end 2 faces the user. The front end 3 faces away from the user.

The felling wedge 1 comprises a handle area 30. In both the exemplary embodiment according to FIGS. 1 to 5 and the exemplary embodiment according to FIG. 6, the handle area 30 is assigned to the base body 10. In the exemplary embodiment according to FIGS. 1 to 5, the handle area 30 is arranged on a handle loop 31. The handle loop 31 is attached to the base body 10. The handle loop 31 straddles the base body 10. In this exemplary embodiment, the handle area 30 is tubular. The handle area 30 is a sub-section of the handle loop 31. In an alternative embodiment according to FIG. 6, the handle area 30 is formed by the base body 10. In this exemplary embodiment, the handle area 30 is a projection of the base body 10. The handle area 30 comprises a recessed handle in the base body 10. In particular, in the exemplary embodiment according to FIG. 6, the handle area 30 can be gripped on both sides by the user's hand. The user's fingers, in particular the user's three-jointed fingers, can rest in the recessed handle of the handle area 30 and at the same time the user's palm and/or thumb can rest against a point on the handle area that lies opposite from the recessed handle. In the exemplary embodiment according to FIG. 6, the handle area 30, in particular around a transverse direction 48 in which the handle area 30 extends, cannot be grasped completely like a tube.

The only difference between the exemplary embodiment according to FIGS. 1 to 5 and the exemplary embodiment according to FIG. 6 is the design of the handle area 30. Otherwise, the description given for the exemplary embodiment according to FIGS. 1 to 5 also applies to the exemplary embodiment according to FIG. 6. Although no battery pack is shown in FIG. 6, the felling wedge 1 according to FIG. 6 also comprises a battery pack.

In all of the exemplary embodiments, the handle area 30 runs transverse to the longitudinal axis 49. As shown in particular in FIG. 4, the handle area 30 runs in a transverse direction 48. The transverse direction 48 is transverse to the longitudinal axis 49. The transverse direction 48 and the extending direction 50 are oriented at a transverse angle α to one another. The transverse angle α is from 60° to 120°, in particular from 80° to 100°. In all of the exemplary embodiments, the transverse angle α is 90°. The transverse direction 48 is perpendicular to the longitudinal axis 49.

In the exemplary embodiments, the handle area 30 extends largely, in particular actually, along a straight line running in the transverse direction 48. However, it can also be provided that the handle area 30 has a curved and/or arcuate profile. The handle area 30 runs in the transverse direction 48 at least at one point. The handle area 30 has longitudinal ends. A straight line which connects the two longitudinal ends of the handle area 30 to each other runs in the transverse direction 48. This defines the transverse direction 48. In the exemplary embodiment according to FIGS. 1 to 5, a longitudinal centre line runs through the handle area 30. The two mutually opposite ends of the longitudinal centre line are positioned on the two mutually opposite longitudinal ends of the handle area 30. In all of the exemplary embodiments, the handle area 30 extends from its first longitudinal end to its second longitudinal end without interruption along a straight line.

As shown in FIG. 4, the felling wedge 1 has a longitudinal median plane E. The longitudinal median plane E contains the longitudinal axis 49 and is perpendicular to the transverse direction 48. The longitudinal median plane E intersects the handle area 30. The longitudinal centre line of the handle area 30 intersects the longitudinal median plane E. At least at the point of intersection where the longitudinal centre line intersects the longitudinal median plane E, the handle area 30, in particular the longitudinal centre line, runs in the transverse direction 48.

In all of the exemplary embodiments, the handle area 30 is the region provided for the user to rest their hand on the felling wedge 1 in order to carry the felling wedge 1, in particular with a single hand, in particular so that the felling wedge 1 hangs below the hand.

The handle area 30 is arranged between the rear end 2 of the felling wedge 1 and the front end 3 of the felling wedge 1, as is apparent in particular in FIGS. 3, 4 or 6. In particular, the handle area 30 is arranged between the rear end 2 and the front end 3 with respect to the extending direction 50. As shown by way of example for all exemplary embodiments in FIG. 4, the felling wedge 1 has a front third 45, a middle third 46 and a rear third 47 in relation to the extending direction 50. The middle third 46 is arranged between the front third 45 and the rear third 47 in relation to the extending direction 50. The front third 45 is assigned to the front end 3 of the felling wedge 1. The rear third 47 is assigned to the rear end 2 of the felling wedge 1. The three thirds 45, 46 and 47 are in each case delimited by planes that are perpendicular to the longitudinal axis 49. Adjacent planes are in each case arranged at the same distance from each other. To divide the felling wedge 1 into the three thirds 45, 46 and 47, four planes are provided. One plane runs through the rear end 2 and another plane runs through the front end 3. The two other planes are arranged between the rear end 2 and the front end 3.

The handle area 30 is arranged with respect to the extending direction 50, in particular in the fully retracted state of the pressure wedge body 20, in the middle third 46 of the felling wedge 1 between the rear end 2 and the front end 3. In the exemplary embodiments, the handle area 30, in particular in the fully retracted state of the pressure wedge body 20, is arranged completely in the middle third 46.

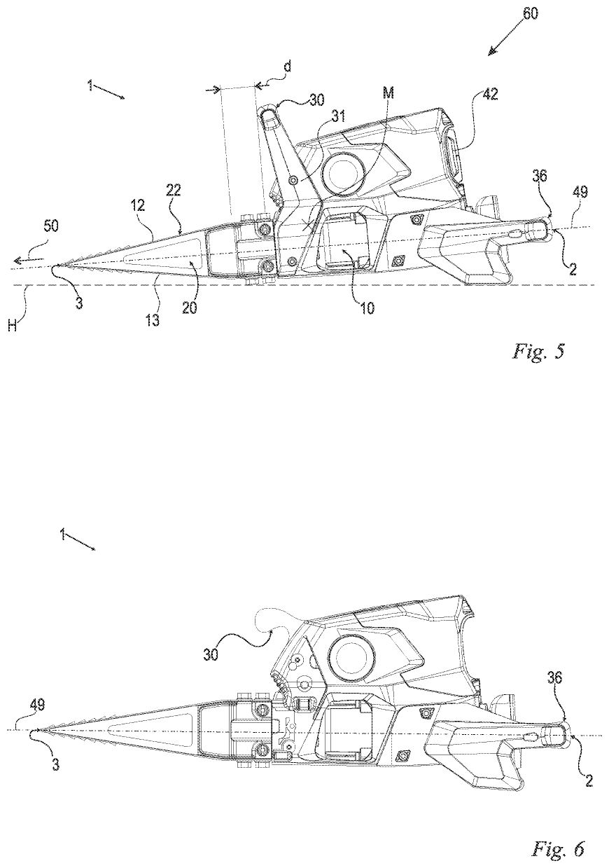

As shown in FIG. 5, the felling wedge 1 has an operating position 60. In the operating position 60, the felling wedge 1 is arranged on a horizontal plane H. In particular, in the operating position 60, the felling wedge 1 is arranged on the horizontal plane H on operating points of the felling wedge 1 provided for this purpose. In the operating position 60 of the felling wedge 1, the handle area 30 is arranged above the longitudinal axis 49. Even when the felling wedge 1 is used as normal, the handle area 30 is arranged above the longitudinal axis 49.

The handle area 30 is arranged at a distance a from the longitudinal axis 49 measured perpendicularly to the longitudinal axis 49. As shown in FIG. 3, the felling wedge 1 has a length b measured in the extending direction 50. The length b is measured in the fully retracted state of the felling wedge 1, in particular of the pressure wedge body 20. The length b is the smallest possible length of the felling wedge 1. The length b corresponds to the distance between the rear end 2 of the felling wedge 1 and the front end 3 of the felling wedge 1. The distance a is at most 50%, in particular at most 30%, in the exemplary embodiment at most 25%, the length b. The distance a is from 10% to 40%, in particular from 20% to 30%, the length b.

As shown in FIGS. 2 and 4, the felling wedge 1 has a centre of mass M. If the felling wedge 1 is oriented towards a vertical plane V such that the transverse direction 48 runs in the direction of the vertical plane V and such that the centre of mass M lies in the vertical plane V, the extending direction 50 pointing away from the vertical plane V is oriented at a, in particular upwardly opening, carrying angle β relative to the vertical plane V. This is shown in FIG. 2. The carrying angle β is from 50° to 90°, in particular from 60° to 80°, in particular from 65° to 75°.

In particular, the extending direction 50 points upwards when the felling wedge 1 is being carried by the handle area 30, in particular with a hand. This is the case in particular due to the position of the centre of mass M. The centre of mass M lies in the middle third 46 of the felling wedge 1. As shown in FIG. 3, the centre of mass M of the felling wedge 1 has a distance c from the longitudinal axis 49 measured perpendicularly to the longitudinal axis 49. The distance c is less than the distance a between the longitudinal axis 49 and the handle area 30. The distance c is less than 30%, in particular less than 20%, in particular less than 10%, the length b of the felling wedge 1. The distance c is less than 50%, in particular less than 30%, in particular less than 20%, the distance a.

The handle area 30 is arranged at a distance e from the centre of mass M that is measured in the extending direction 50, as shown in FIG. 3. The distance e is less than the distance a. The distance e is from 80% to 120%, in particular from 90% to 110%, of the distance c. The distance e is at least 3%, in particular at least 5%, of the length b of the felling wedge 1. The distance e is less than 30%, in particular less than 20%, in particular less than 10%, of the length b of the felling wedge 1. The centre of mass M is arranged behind the handle area 30 with respect to the extending direction 50. The centre of mass M is arranged closer to the rear end 2 than the handle area 30 with respect to the extending direction 50.

As shown in FIG. 3, the pressure wedge body 20 has an inclined surface 22. The inclined surface 22 runs at an angle to the longitudinal axis 49. The inclined surface 22 runs at an angle to the extending direction 50. The inclined surface 22 does not include any parts of the pressure wedge body 20 which run parallel to the longitudinal axis 49, in particular to the extending direction 50. The handle area 30 is arranged at a hand clearance distance d from the inclined surface 22 measured in the extending direction 50. The hand clearance distance d is at least 3 cm, in particular at least 4 cm, in particular at least 5 cm. The hand clearance distance d is less than 20 cm, in particular less than 10 cm. The hand clearance distance d is at least 2%, in particular at least 3%, in particular at least 5%, of the length b of the felling wedge 1. The hand clearance distance d is at most 20%, in particular at most 10%, of the length b of the felling wedge 1.

The longitudinal median plane E shown in FIG. 4 runs perpendicularly to the inclined surface 22. When the felling wedge 1 is in its usual use position to fell a tree, the longitudinal median plane E runs in a vertical direction. The transverse direction 48 is defined in particular by the fact that it runs transverse to the longitudinal median plane E. The transverse direction 48 is oriented towards the longitudinal median plane E at the transverse angle α. The transverse angle α is from 60° to 120°, in particular from 80° to 100°. In all of the exemplary embodiments, the transverse angle α is 90°. The transverse direction 48 runs perpendicularly to the longitudinal median plane E.

In all of the exemplary embodiments, the felling wedge 1 comprises a rear handle 36. The rear handle 36 is arranged behind the handle area 30 with respect to the extending direction 50. The handle 36 faces the user when the felling wedge 1 is in use. The handle area 30 faces away from the user when the felling wedge 1 is in use.

The rear handle 36 is a handle loop. The rear handle 36 forms the rear end 2 of the felling wedge 1 in the exemplary embodiments. The user can fully grasp the rear handle 36 with their hand.

The felling wedge 1 comprises a battery pack 42. This applies to both the exemplary embodiment according to FIGS. 1 to 5 and to the exemplary embodiment according to FIG. 6, even though no battery pack is shown in FIG. 6. The battery pack 42 is used to supply the drive unit 40, in particular the motor 41, with electrical power. The battery pack 42 is arranged in all of the exemplary embodiments with respect to the extending direction 50 between the handle area 30 and the rear handle 36. In the operating position 60 of the felling wedge 1, the battery pack 42 is arranged above the longitudinal axis 49. In the operating position 60 of the felling wedge 1, the battery pack 42 is arranged above the centre of mass M of the felling wedge 1.

The felling wedge 1 comprises a control element 44 for controlling the drive unit 40, in particular for controlling the motor 41. The control element 44 can be arranged on the base body 10, in particular as a part of the base body 10, in such a way that when the rear handle 36 is held, in particular grasped, it can be controlled with the same hand. The control element 44 can be moved together with the base body 10 in relation to the pressure wedge body 20. It can be provided that the control element 44 is designed as a display and/or as a panel. It can be provided that the control element 44 is a fixed component part of the base body 10. In the exemplary embodiments, however, the control element 44 can be removed from the base body 10. The control element 44 can be used in the exemplary embodiments as a remote control. If the control element 44 designed as a remote control is arranged on the base body 10, it is arranged such that, when the rear handle 36 is held, in particular grasped, with one hand, the control element can be controlled with the same hand.

As shown in FIG. 4, the felling wedge 1 comprises at least one rear attachment point 4 and at least one front attachment point 5. The rear attachment point 4 is also shown in FIG. 3. The attachment points 4 and 5 are used to attach a carrying strap 6. The carrying strap 6 is shown schematically in FIG. 4. The carrying strap 6 is used to transport the felling wedge 1. The carrying strap 6 can be used as a shoulder strap. In the exemplary embodiments, the at least one rear attachment point 4 is provided on the rear handle 36. As is apparent in FIG. 1, two rear attachment points 4 are provided. It can also be provided that the rear attachment point 4 is arranged on the base body 10. In the exemplary embodiments, both the at least one rear attachment point 4 and the at least one front attachment point 5 are designed as passage openings.

As shown in particular in FIG. 3, the felling wedge 1 comprises two wedge jaws 12 and 13. The wedge jaws 12 and 13 are each intended to be arranged between the tree to be felled and the pressure wedge body 20. The two wedge jaws 12 and 13 are fixed to the base body 10. The at least one engagement means 11 is provided in the exemplary embodiments both on the wedge jaw 12 and also on the wedge jaw 13. The two wedge jaws 12, 13 are flexible. When the pressure wedge body 20 is extended in the extending direction 50, the two wedge jaws 12 and 13 can be pushed apart by the pressure wedge body 20. The two wedge jaws 12 and 13 lie opposite each other. The longitudinal axis 49 is arranged between the wedge jaw 12 and the wedge jaw 13. The wedge jaws 12 and 13 are not connected to each other at the front end 3. In the fully retracted state of the felling wedge 1, in particular of the pressure wedge body 20, the two wedge jaws 12 and 13 bear against each other. The front end 3 is formed by the wedge jaws 12 and 13. This applies at least to the fully retracted state of the felling wedge 1, in particular of the pressure wedge body 20. The at least one front attachment point 5 is arranged in the exemplary embodiments on at least one of the two wedge jaws 12 and 13. In the exemplary embodiments, only a single front attachment point 5 is provided. It can also be provided that the at least one front attachment point 5 is provided on the handle loop 31.

1.-20. (canceled)

21. A felling wedge, comprising:
a base body (10) having a handle area (30);
a pressure wedge body (20) moveable relative to the base body (10); and
a drive unit (40) configured to move the pressure wedge body (20) relative to the base body (10) along a longitudinal axis (49) in an extending direction (50)
wherein the felling wedge (1) has a rear end (2) and a front end (3) with respect to the extending direction (50),
wherein the handle area (30) extends in a transverse direction (48) transverse to the longitudinal axis (49), and
wherein the handle area (30) is arranged between the rear end (2) and the front end (3).

22. The felling wedge according to claim 21,
wherein the handle area (30) is arranged, with respect to the extending direction (50), in a middle third (46) of the felling wedge (1) between the rear end (2) and the front end (3).

23. The felling wedge according to claim 21,
wherein the felling wedge (1) has an operating position (60) in which the felling wedge (1) is arranged on a horizontal plane (H), and
wherein, in the operating position (60), the handle area (30) is arranged above the longitudinal axis (49).

24. The felling wedge according to claim 21,
wherein the felling wedge (1) has a centre of mass (M),
wherein, when the handle area (30) and the centre of mass (M) are arranged in a vertical plane (V) extending in the transverse direction (48), the extending direction (50) pointing away from the vertical plane (V) is oriented at a carrying angle (β) relative to the vertical plane (V), and
wherein the carrying angle (β) is from 50° to 90°.

25. The felling wedge according to claim 21,
wherein the handle area (30) is tubular.

26. The felling wedge according to claim 21,
wherein the handle area (30) is formed by a handle loop (31) that straddles the base body (10).

27. The felling wedge according to claim 21,
wherein the transverse direction (48) and the extending direction (50) are oriented at a transverse angle (α) relative to each other, and
wherein the transverse angle (α) is from 60°to 120°.

28. The felling wedge according to claim 21,
wherein the pressure wedge body (20) has an inclined surface (22) extending at an angle relative to the longitudinal axis (49), and
wherein the handle area (30) is arranged at a hand clearance distance (d) from the inclined surface (22), the hand clearance distance (d) being measured in the extending direction (50).

29. The felling wedge according to claim 28,
wherein the hand clearance distance (d) is at least 3 cm.

30. The felling wedge according to claim 21,
further comprising a rear handle (36) arranged behind the handle area (30) with respect to the extending direction (50).

31. The felling wedge according to claim 30,
wherein the rear handle (36) is a handle loop.

32. The felling wedge according to claim 30,
wherein the rear handle (36) forms the rear end (2) of the felling wedge (1).

33. The felling wedge according to claim 30,
further comprising a battery pack (42),
wherein the battery pack (42) is arranged between the handle area (30) and the rear handle (36) with respect to the extending direction (50).

34. The felling wedge according to claim 30,
further comprising a control element (44) for controlling the drive unit (40),
wherein the control element (44) is arranged such that, when the rear handle (36) is being held with one hand, the control element can be controlled with the same hand.

35. The felling wedge according to claim 34,
wherein the control element (44) is arranged on the base body (10) such that it forms a movement unit with the base body (10) when the pressure wedge body (20) moves relative to the base body (10).

36. The felling wedge according to claim 34,
wherein the control element is removable from the base body (10) and usable as a remote control.

37. The felling wedge according to claim 30,
further comprising at least one rear attachment point (4) and at least one front attachment point (5) for attaching a carrying strap (6) for the felling wedge (1),
wherein the at least one rear attachment point (4) is arranged on the rear handle (36) or the base body (10).

38. The felling wedge according to claim 37,
wherein the at least one rear attachment point (4) is configured as a passage opening.

39. The felling wedge according to claim 37,
wherein the at least one front attachment point (5) is configured as a passage opening.

40. The felling wedge according to claim 37,
further comprising two wedge jaws (12, 13), each arranged for placement between a tree and the pressure wedge body (20),
wherein the two wedge jaws (12, 13) are fixed to the base body (10), and
wherein the at least one front attachment point (5) is arranged on the handle loop (31) or on at least one of the two wedge jaws (12, 13).
